(19) United States
(12) Patent Application Publication
(10) Pub. No.: US 2013/0315194 A1
(43) Pub. Date: Nov. 28, 2013

(54) DEVICE AND METHOD FOR ADJUSTING COEXISTENCE INFERENCE IN A DEVICE IN A WIRELESS COMMUNICATION SYSTEM

(71) Applicants: Jae Hyun Ahn, Seoul (KR); Ki Bum Kwon, Seoul (KR); Myung Cheul Jung, Seoul (KR)

(72) Inventors: Jae Hyun Ahn, Seoul (KR); Ki Bum Kwon, Seoul (KR); Myung Cheul Jung, Seoul (KR)

(73) Assignee: Pantech Co., Ltd, Seoul (KR)

(21) Appl. No.: 13/984,827

(22) PCT Filed: Feb. 10, 2012
(86) PCT No.: PCT/KR12/01032

§ 371 Date: Aug. 9, 2013

(30) Foreign Application Priority Data
Feb. 10, 2011 (KR) 10-2011-0012058
Feb. 9, 2012 (KR) 10-2012-0013487
Feb. 10, 2012 (KR) 10-2012-0013989

(51) Int. Cl. H04W 72/08

(52) U.S. Cl. CPC H04W 72/082
USPC 370/329

(57) ABSTRACT

A device and method for adjusting coexistence inference in a device in a wireless communication system includes: detecting interference caused by transmission in a first frequency band of a first network system with respect to reception in a second frequency band of a second network system; transmitting support information that supports the adjustment of the detected interference to a base station when a prohibit timer that prevents delivery of interference information for a predetermined period is expired; and receiving from the base station reply information on accepting or rejecting the adjustment of the detected interference in response to the support information. The procedures for processing coexistence interference in a device become simplified, are easily implemented, and maintain backward compatibility to other typical procedures. Moreover, since information on coexistence interference in a device is clearly defined, the uncertainty of interference adjustment procedures may be resolved.

### CROSS-REFERENCED TO RELATED APPLICATIONS

This application is the National Stage Entry of International Application PCT/KR2012/001032, filed on Feb. 10, 2012, and claims priority and the benefit of Korean Patent Application Nos. 10-2011-0012058, filed on Feb. 10, 2011, 10-2012-0013487, filed on Feb. 9, 2012 and 10-2012-0013989, filed on Feb. 10, 2012, all of which are incorporated herein by reference for all purposes as if fully set forth herein.

### FIELD

The present invention relates to wireless communication, and more specifically, to an apparatus and method for adjusting in-device co-existence interference in a wireless communication system by using a prohibit timer.

### DISCUSSION OF THE BACKGROUND

Wireless communication systems generally use one bandwidth for data transmission. For example, second generation wireless communication systems use bandwidths between 200 KHz and 1.25 MHz, and third generation wireless communication systems use bandwidths between 5 MHz and 10 MHz. In order to support increasing transmission capacity, the 3GPP (3rd Generation Partnership Project) LTE (Long Term Evolution) or IEEE 802.16m has been recently expanding the bandwidth up to 20 MHz or more. Increasing the bandwidth may be inevitable to raise transmission capacity, but supporting a large bandwidth even when low-level services are required may increase power consumption.

Accordingly, a multiple component carriers system has been introduced that may define a carrier having a single bandwidth and a center frequency and that enables transmission and/or reception of data over a broadband through a plurality of carriers. One or more carriers are used to support a narrow band and a broad band at the same time. For example, if one carrier corresponds to a bandwidth of 5 MHz, four carriers are used to support a bandwidth up to 20 MHz.

Thanks to nowadays ubiquitous access networks, users may gain access to different networks at different regions and may continue the access anywhere. Conventionally, one terminal conducts communication with one network system, and a user needs to carry different devices that support different network systems, respectively. However, as a terminal has more advanced and sophisticated functions, the terminal may simultaneously communicate with multiple network systems, thus providing users with increased convenience.

However, if one terminal conducts simultaneous communication over multiple network system bands, in-device coexistence interference may occur. The in-device co-existence interference means when, in the same terminal, transmission over a frequency band interferes with reception over the same frequency band. For example, in-device co-existence interference may occur between a Bluetooth system band and a 802.16 system band in case one terminal supports both a Bluetooth system and a 802.16 system. In-device co-existence interference may be generally created when the gap in boundary between frequency bands of heterogeneous network systems is not sufficiently large.

One technology to avoid in-device co-existence interference may be a frequency division multiplexing (FDM) scheme. The FDM scheme adjusts interference by avoiding a band where in-device co-existence interference occurs. However, no discussion is undergoing regarding specific operational procedures between a terminal and a base station for adjusting in-device co-existence interference by the FDM scheme.

### SUMMARY

An object of the present invention is to provide an apparatus and method for adjusting in-device co-existence interference.

An object of the present invention is to provide an apparatus and method for adjusting in-device co-existence interference by using a prohibit timer.

An object of the present invention is to provide an apparatus and method for configuring a message including a timer value for driving a prohibit timer.

An object of the present invention is to provide an apparatus and method for transmitting and receiving a timer value for driving a prohibit timer.

Another object of the present invention is to provide an apparatus and method for detecting whether in-device co-existence interference occurs.

Still another object of the present invention is to provide an apparatus and method for effectively indicating whether in-device co-existence interference occurs.

Yet still another object of the present invention is to provide an apparatus and method for adjusting in-device co-existence interference by frequency shifting.

Yet still another object of the present invention is to provide an apparatus and method for adjusting in-device co-existence interference by frequency shaping.

Yet still another object of the present invention is to provide an apparatus and method for adjusting in-device co-existence interference based on an FDM scheme.

According to an aspect of the present invention, there is provided a method of adjusting interference by a terminal in a wireless communication system. The method comprises detecting interference caused by transmission over a first frequency of a first network system in reception over a second frequency band of a second network system, transmitting, to a base station, assistance information to support adjustment of the detected interference in a case where a prohibit timer is expired of preventing transfer of interference information during a predetermined period of time and receiving, from the base station, response information to accept or reject adjustment of the detected interference in response to the assistance information.

According to another aspect of the present invention, there is provided a terminal performing interference adjustment in a wireless communication system. The terminal comprises an interference detecting unit that detects interference caused by transmission over a first frequency band of a first network system in reception over a second frequency band of a second network system, a assistance information generating unit that generates assistance information to support adjustment of the detected interference, a assistance information transmitting unit that transmits the assistance information to the base station in a case where a prohibit timer is expired of preventing transfer of the interference information during a predetermined period of time, and a response information receiving unit that receives from the base station response information to accept or reject adjustment of the detected interference in response of the assistance information.

According to still another aspect of the present invention, there is provided a method of adjusting interference by a base station in a wireless communication system. The method comprises receiving from a terminal information regarding interference caused by transmission over a first frequency band of a first network system in reception over a second frequency band of a second network system, determining whether to adjust the interference, and transmitting to the terminal response information on accepting or rejecting the adjustment of the interference.

According to yet still another aspect of the present invention, there is provided a base station performing interference adjustment in a wireless communication system. The base station comprises a assistance information receiving unit receiving from a terminal assistance information that is information regarding interference caused by transmission over a first frequency band of a first network system in reception over a second frequency band of a second network system, an interference adjustment determining unit determining whether to adjust the interference, a response information transmitting unit transmitting to the terminal response information on accepting or rejecting the adjustment of the interference, and a scheduling unit performing scheduling to adjust the interference.

According to the present invention, the procedure of treating in-device co-existence interference may be simplified and may be easily implemented, and backward-compatibility with other procedures may be maintained. Further, since information regarding in-device co-existence interference as exchanged between the terminal and the base station may be clearly defined, thus addressing uncertainty of the process of adjusting interference. Further, unnecessary exchange of information regarding in-device co-existence interference may be skipped, so that the interference adjusting procedure may be optimized.

Further, the present invention allows for efficient use of limited wireless resources of the base station by preventing frequent interference report of occurrence of interference by using a prohibit timer. That is, frequent transmission and reception of information regarding in-device co-existence interference may be prevented between the terminal and the base station, thus resulting in the interference adjusting procedure being optimized.

### BRIEF DESCRIPTION OF THE DRAWINGS

FIG. 1 illustrates a wireless communication system to which embodiments of the present invention are applied.

FIG. 2 illustrates in-device co-existence interference.

FIG. 3 shows an example in which an ISM transmitter causes in-device co-existence interference in an LTE receiver.

FIG. 4 shows an example in which a frequency band is split into ISM bands and LTE bands.

FIG. 5 illustrates an example in which an FDM scheme is used to mitigate in-device co-existence interference.

FIG. 6 illustrates another example in which an FDM scheme is used to mitigate in-device co-existence interference.

FIG. 7 illustrates an example in which a TDM scheme is used to mitigate in-device co-existence interference.

FIG. 8 illustrates transmission and reception timings on the time axis in an LTE band an ISM band.

FIG. 9 is a flowchart illustrating a method of transmitting information regarding in-device co-existence interference according to an embodiment of the present invention.

FIGS. 10 to 12 are views illustrating a method of performing adjustment of in-device co-existence interference by frequency shifting or shaping according to an embodiment of the present invention.

FIG. 13 is a flowchart illustrating a method of transmitting information regarding in-device co-existence interference by a terminal according to an embodiment of the present invention.

FIG. 14 is a flowchart illustrating a method of transmitting information regarding in-device co-existence interference by a base station according to an embodiment of the present invention.

FIG. 15 is a block diagram illustrating an apparatus of transmitting information regarding in-device co-existence interference according to an embodiment of the present invention.

FIG. 16 is a view illustrating a method of detecting in-device co-existence interference according to an embodiment of the present invention.

FIG. 17 is a view illustrating a specific operation of a prohibit timer according to the present invention.

### DETAILED DESCRIPTION OF THE ILLUSTRATED EMBODIMENTS

Hereinafter, some embodiments of the disclosure will be described in detail with reference to the accompanying drawings. The same reference numbers are used to denote the same elements throughout the specification and the drawings. When determined to make the gist of the present invention unclear, the detailed description of the related elements or functions will be skipped.

As used herein, the terms “first,” “second,” “A,” “B,” “(a),” and “(b)” are used only to distinguish a component from another component and do not limit the gist, order, or sequence thereof. When a component is “connected,” “coupled,” or “combined” with another component, the component may be directly connected, coupled, or combined with the other component. Or, other components may intervene.

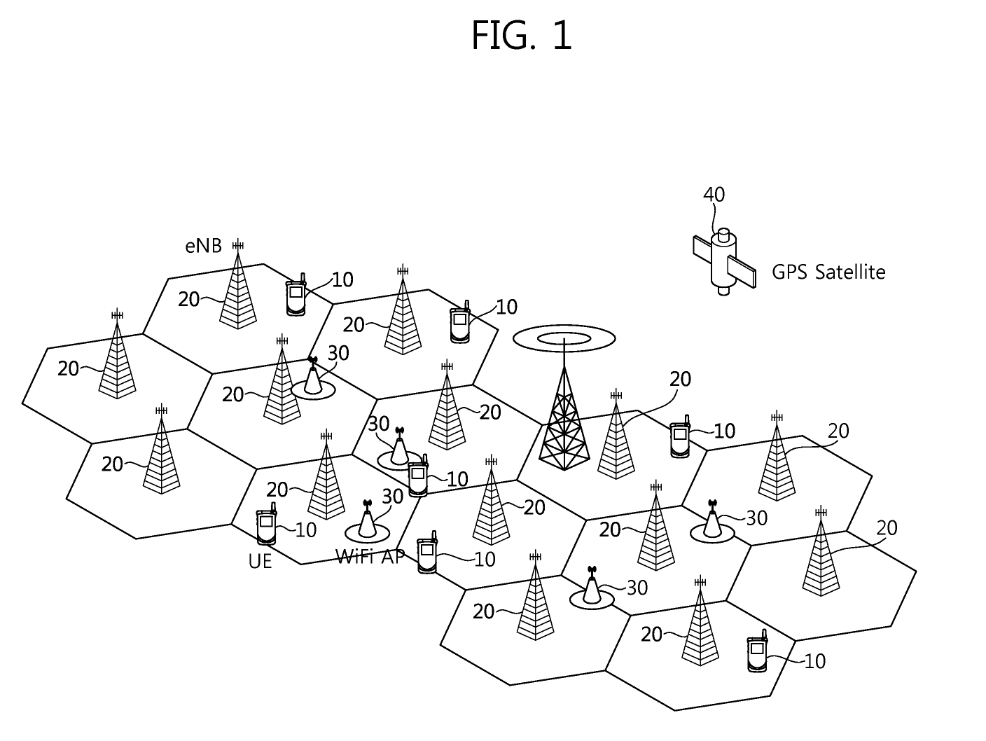

FIG. 1 illustrates a wireless communication system to which embodiments of the present invention are applied.

Referring to FIG. 1, the wireless communication system includes terminals 10 (user equipment, UE), base stations 20 (evolved NodeB, eNB), wireless LAN access points (AP) 30, and a GPS (Global Positioning System) satellite 40, which are distributed to provide communication services. Here, the wireless LAN AP is a device that supports a wireless LAN standard, IEEE 802.11. IEEE 802.11 may also refer to a WiFi system.

The terminal 10 may be positioned in coverage of multiple networks such as a cellular network, a wireless LAN, a broadcast network, or a satellite system. A recent terminal 10 includes multiple wireless transceivers in order to access various networks and services anytime and anywhere. For example, a smart phone has an LTE, WiFi, and Bluetooth transceiver and a GPS receiver. As such, for more transceivers to be incorporated into a single terminal 10 while maintaining good performance, the terminal 10 has a more complicated design. Accordingly, in-device co-existence interference is more likely to occur.

Hereinafter, the “downlink” means communication from the base station 20 to the terminal 10, and the “uplink” means communication from the terminal 10 to the base station 20. On downlink, a transmitter may be part of the 20, and a receiver may be part of the terminal 10. On uplink, a transmitter may be part of the terminal 10, and a receiver may be part of the base station 20.

The terminal 10 may be fixed at a position or may be mobile. The terminal 10 may be referred to as MS (Mobile Station), UT (User Terminal), SS(Subscriber Station), MT (Mobile Terminal), or wireless device. The base station 20 is a fixed station that communicates with the terminal 10, and may be referred to as BS (Base Station), BTS (Base Transceiver System), access point, femto BS, or relay.

The wireless communication system is not limited as adopting a specific multiple access scheme. Various multiple access schemes may be adopted such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, or OFDM-CDMA. The TDD (Time Division Duplex) scheme in which uplink transmission and downlink transform matrix are conducted at different times and the FDD (Frequency Division Duplex) scheme in which uplink transform matrix and downlink transform matrix are conducted using different frequencies may be adopted.

The “carrier aggregation (CA)” supports a plurality of component carriers and is also referred to as spectrum aggregation or bandwidth aggregation. Each of unit carriers grouped by carrier aggregation is referred to as a component carrier (hereinafter, “CC”). Each CC is defined with a bandwidth and a center frequency. The carrier aggregation has been introduced to back up increasing throughput, prevent an increase in costs due to introduction of wideband RF (Radio Frequency) elements, and ensure compatibility with existing systems. For example, if five CCs each having a bandwidth of 5 MHz are provided as a granularity, a bandwidth up to 25 Mhz may be supported. Hereinafter, the “multi-carrier system” refers to a system that supports carrier aggregation. The wireless communication system shown in FIG. 1 may be a multi-carrier system.

A system frequency band is split into a plurality of carrier frequencies. Here, each carrier frequency means the center frequency of a cell. The cell may mean a downlink CC and an uplink CC. Or, the cell may mean a combination of a downlink CC and an optional uplink CC. Further, when no carrier aggregation is considered, one cell generally has a pair of uplink and downlink CCs.

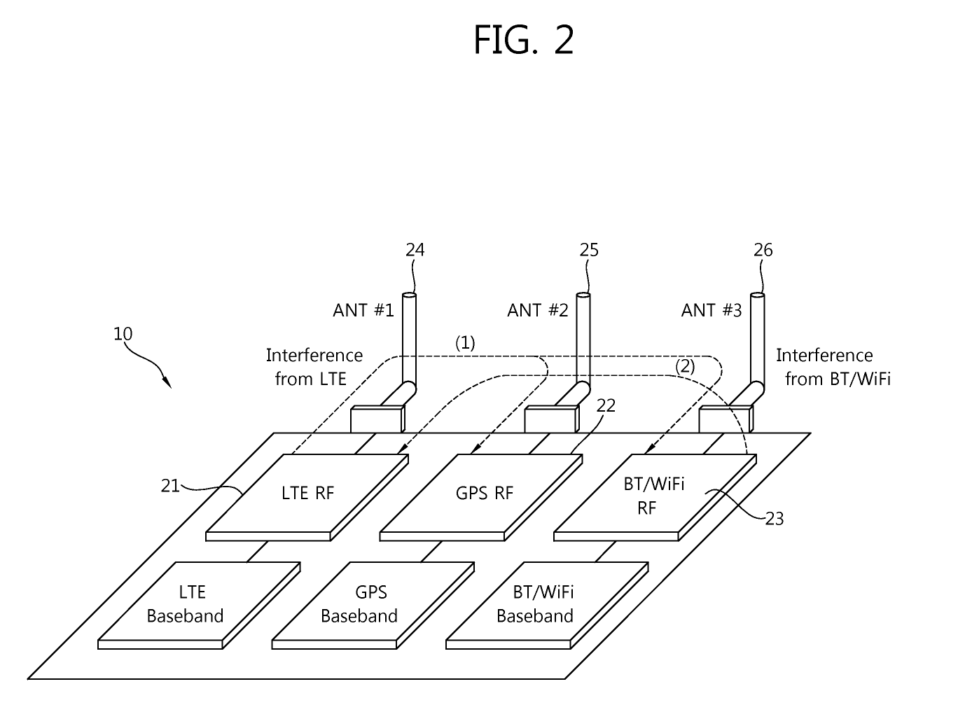

FIG. 2 illustrates in-device co-existence interference.

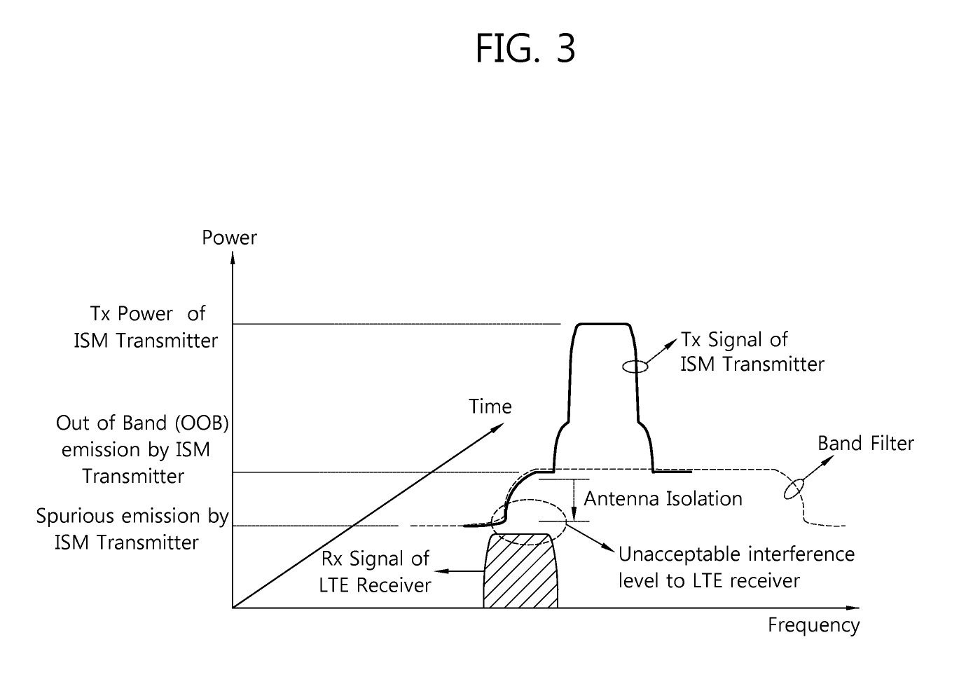

Referring to FIG. 2, the terminal 20 includes an LTE RF 21, a GPS RF 22, and a Bluetooth/WiFi RF 23. The RFs are connected with antennas 24, 25, and 26, respectively. That is, a number of types of RFs are mounted adjacent to each other in a single device platform. Here, transmission power of one RF may be considerably larger than reception power of another RF. At this time, if a frequency gap between the RFs is not large enough and no filtering technology is backed up, a transmission signal from one RF may cause tremendous interference in the receiver of another RF. Such interference is referred to as in-device co-existence interference (IDC). For example, (1) shows an example in which a transmission signal from the LTE RF 21 causes in-device co-existence interference in the GPS RF 22 and the Bluetooth/WiFi RF 23, and (2) shows an example in which a transmission signal from the Bluetooth/WiFi RF 23 causes in-device co-existence interference in the LTE RF 21. This issue is described below in greater detail with reference to FIG. 3.

FIG. 3 shows an example in which an ISM (Industrial, Scientific and Medical) transmitter causes in-device co-existence interference in an LTE receiver. The ISM band represents a band that may be freely used without the need of permission for use in the industrial, scientific, and medical fields.

Referring to FIG. 3, it can be seen that the band of a signal received by the LTE receiver overlaps the band of a signal transmitted from the ISM transmitter. In such case, in-device co-existence interference may take place.

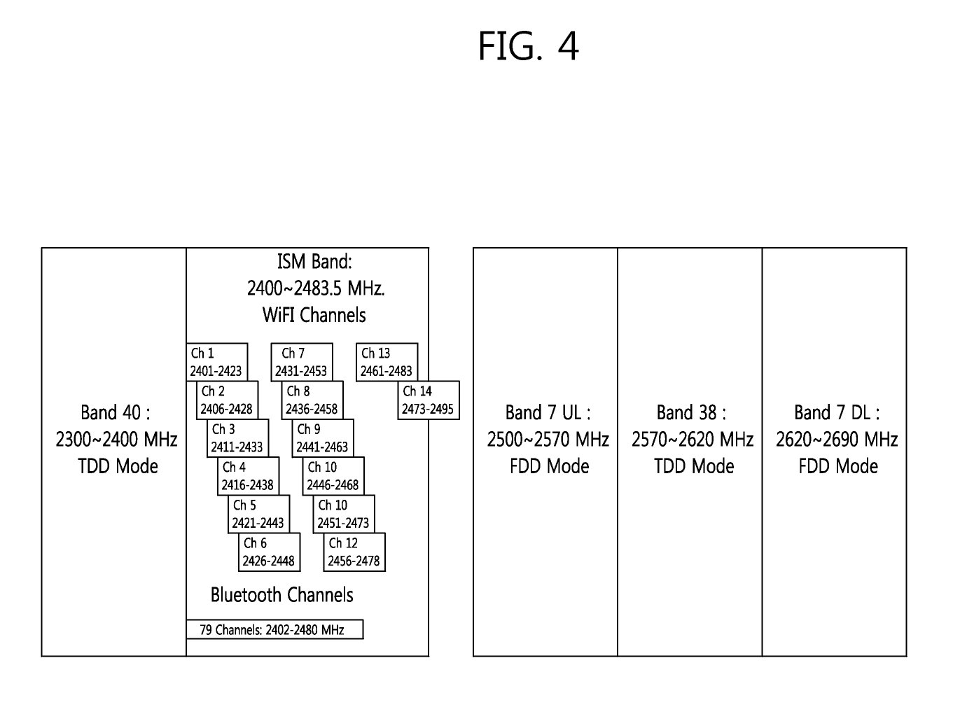

FIG. 4 shows an example in which a frequency band is split into ISM bands and LTE bands.

Referring to FIG. 4, band 40, band 7, and band 38 are LTE bands. Band 40 takes up 2300 to 2400 MHz in TDD mode, and band 7 takes up 2500 to 2570 MHz on uplink in FDD mode. Band 38 takes up 2570 to 2620 MHz in TDD mode. Meanwhile, the ISM bands are used for WiFi channels and Bluetooth channels and occupy 2400 to 2483.5 MHz. Here, the following shows situations where in-device co-existence interference occurs.

TABLE 1

| Interference band | Type of interference |
|---|---|
| band 40 | ISM Tx −> LTE TDD DL Rx |
| band 40 | LTE TDD UL Tx −> ISM Rx |
| band 7 | LTE FDD UL Tx −> ISM Rx |
| band 7/13/14 | LTE FDD UL Tx −> GPS Rx |

Referring to Table 1, in the type of interference, ‘a→b’ represents the situation where transmitter a causes in-device co-existence interference in receiver b. Accordingly, on band 40, the ISM transmitter causes in-device co-existence interference in the downlink TDD receiver (LTE TDD DL Rx) with the LTE band. A filtering scheme may slightly mitigate in-device co-existence interference but is not enough. Applying an FDM scheme in addition to the filtering scheme may reduce in-device co-existence interference more efficiently.

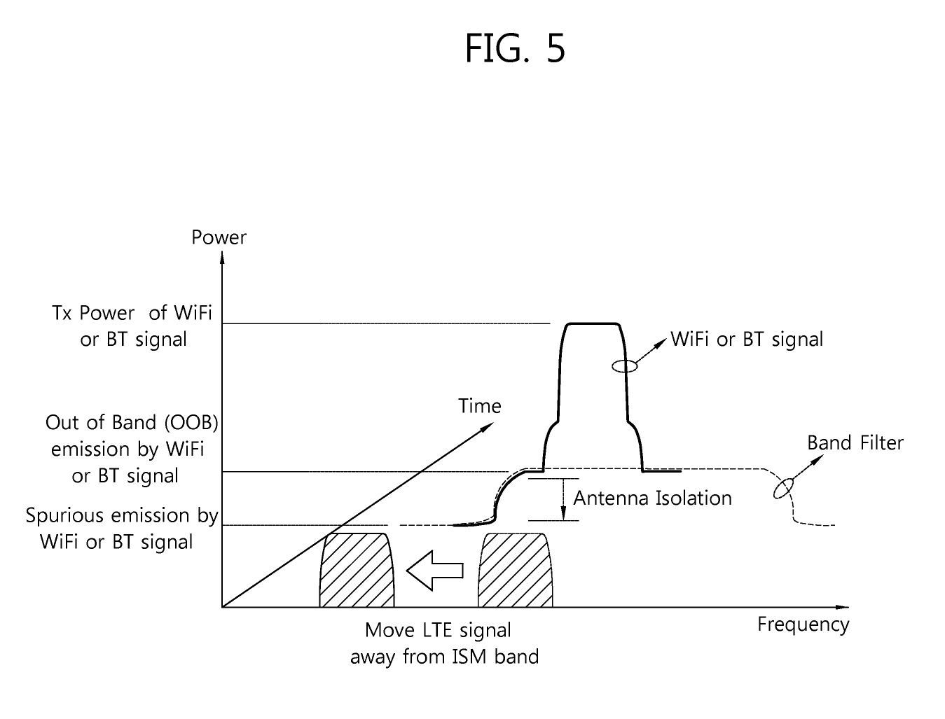

FIG. 5 illustrates an example in which an FDM scheme is used to mitigate in-device co-existence interference.

Referring to FIG. 5, the LTE band may be shifted not to overlap the ISM band. This resultantly induces handover of the terminal from the ISM band. However, for such purpose, a method is required of legacy measurement or new signaling exactly triggering a mobility procedure or RLF (radio link failure) procedure.

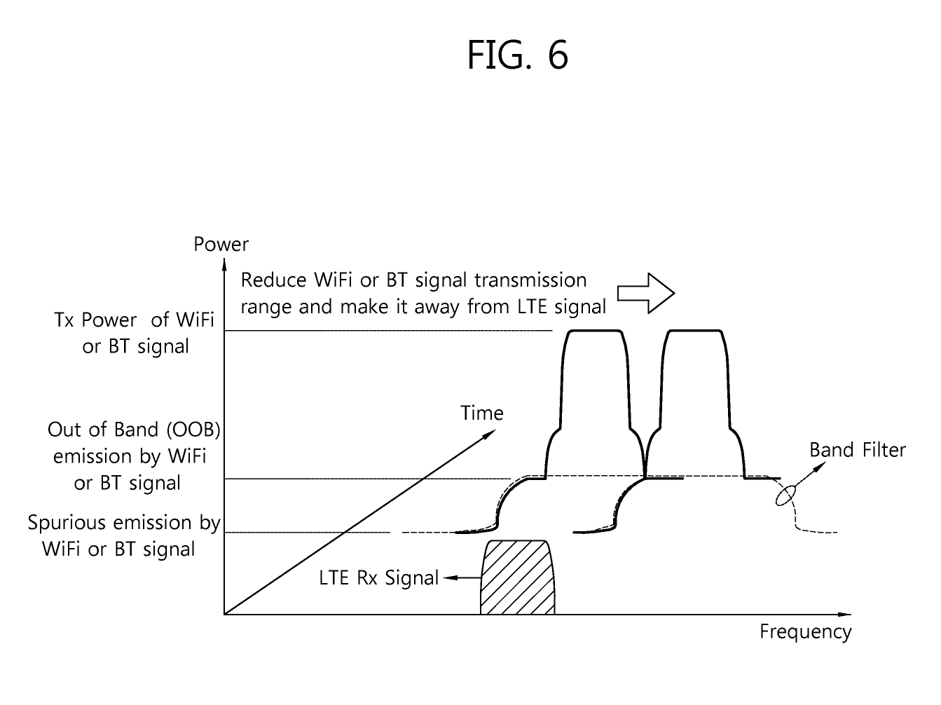

FIG. 6 illustrates another example in which an FDM scheme is used to mitigate in-device co-existence interference.

Referring to FIG. 6, the ISM band may be reduced to be apart from the LTE band. However, such scheme raises a backward compatibility issue. Bluetooth may address the backward-compatibility issue to some degree thanks to its adaptive frequency hopping mechanism. However, WiFi may have difficulty in solving the backward-compatibility issue.

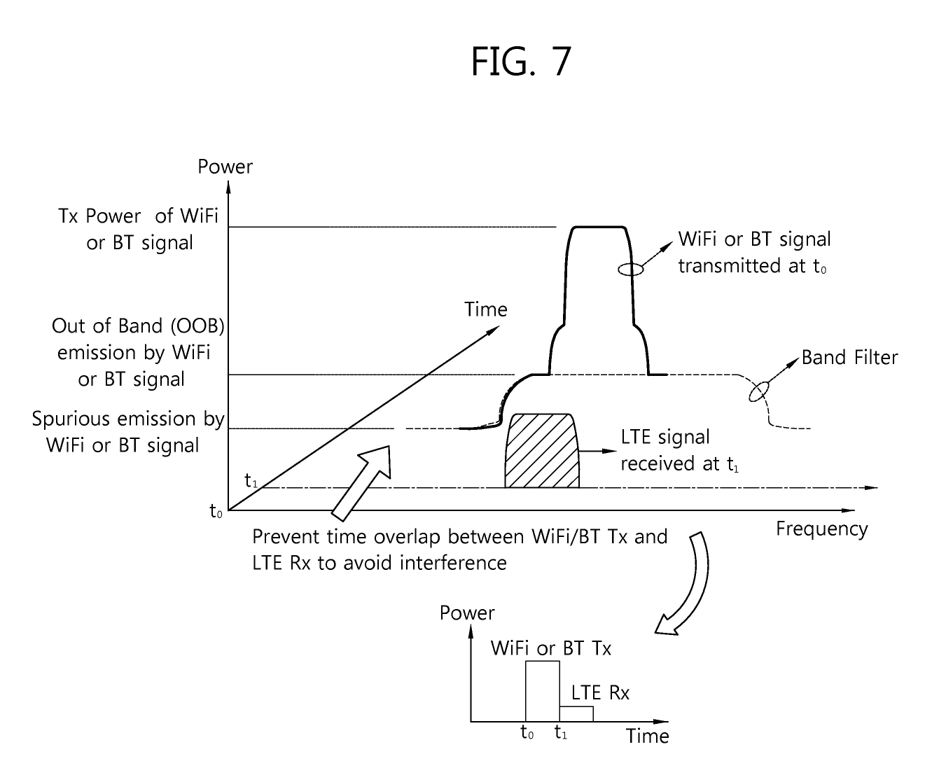

FIG. 7 illustrates an example in which a TDM scheme is used to mitigate in-device co-existence interference.

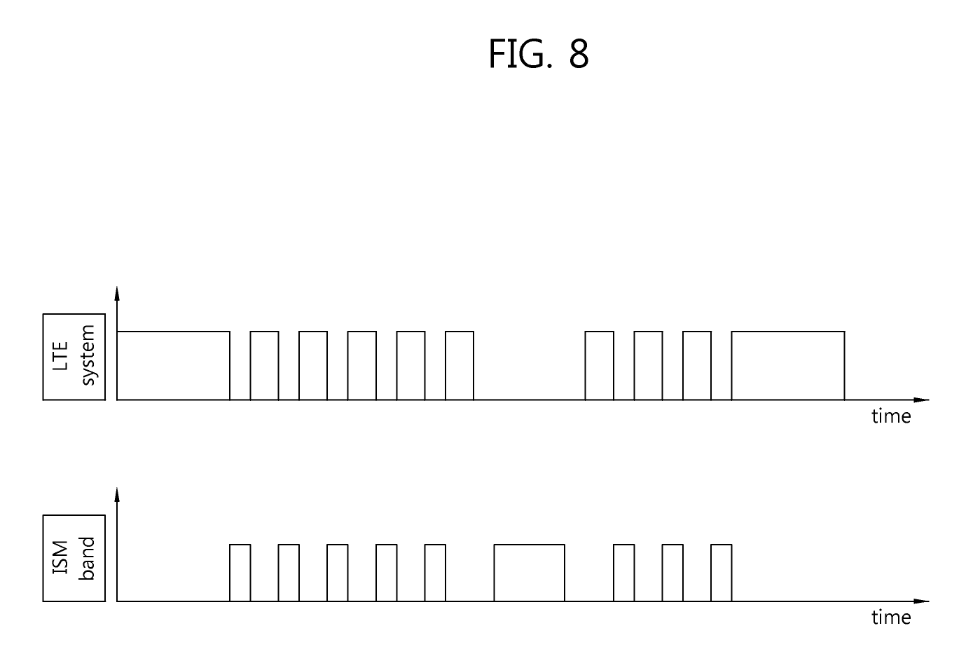

Referring to FIG. 7, in-device co-existence interference may be avoided by rendering the LTE band reception time not to overlap the ISM band transmission time. For example, an LTE band signal is configured to be received at t1 in case an ISM band signal is transmitted at to. As such, transmission/reception timings on time axis of the LTE band and ISM band using the TDM scheme may be shown as in FIG. 8. By such scheme, in-device co-existence interference may be avoided even without a shift between the LTE band and the ISM band.

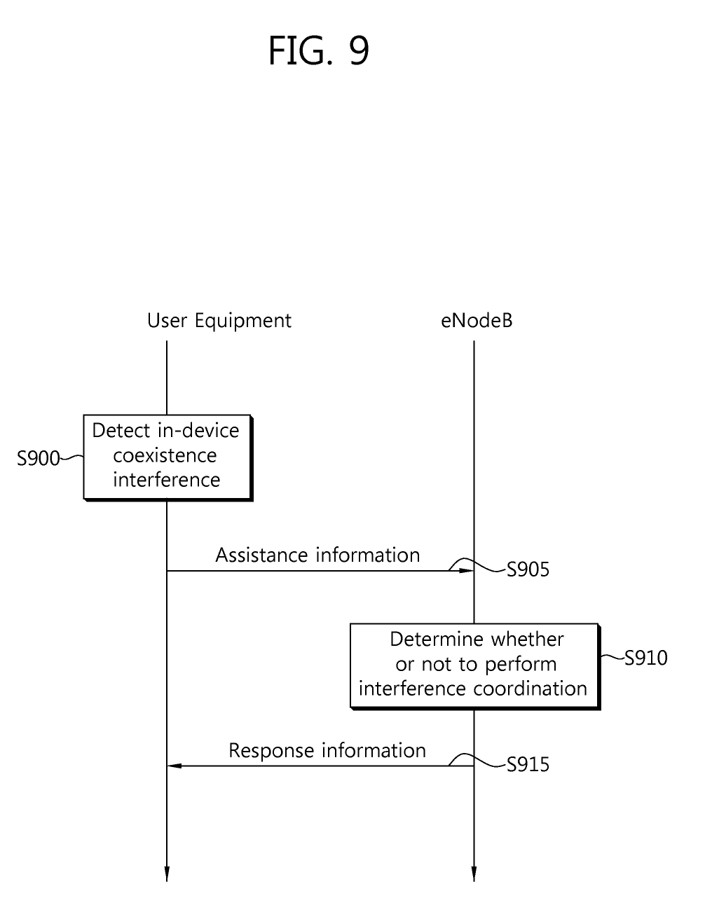

FIG. 9 is a flowchart illustrating a method of transmitting information regarding in-device co-existence interference according to an embodiment of the present invention.

Referring to FIG. 9, the terminal detects in-device co-existence interference (S900). The in-device co-existence interference may occur, e.g., when transmission from the terminal to a peripheral device performing communication through Bluetooth or WiFi causes interference in reception of the terminal from an LTE system base station. Under the situation as shown in FIG. 2, the terminal detects whether a signal transmitted from other RF causes interference in a received signal of the LTE RF. For example, assume that the terminal transmits a signal through other RF such as WiFi while receiving signal x from the base station through the LTE RF.

By way of example, the terminal may detect in-device co-existence interference using a signal to interference noise ratio (SINR). When the SINR of signal y is large enough to be not less than a predetermined threshold and thus acts as interference in signal x, the terminal may detect occurrence of in-device co-existence interference. As another example, the terminal may detect in-device co-existence interference using RSRP (Reference Signal Received Power) or RSRQ (Reference Signal Received Quality).

At this time, the terminal may define a blank transmission region for transmission of the peripheral device and may put a restriction on the transmission resource of the peripheral device. The blank transmission may be an example of the TDM scheme. At this time, depending on the circumstance, a too low transmission rate may be allocated to the peripheral device so that voice and streaming services may be impossible. In such case, although interference adjustment has been done based on the TDM scheme, if an available frequency band is created, the terminal may re-attempt interference adjustment based on the FDM scheme.

As another example, in case the data transmission rate of signal y is larger than a threshold, the terminal may detect in-device co-existence interference.

As still another example, when the status where the strength of signal y is larger than a threshold lasts a predetermined period of time, the terminal may determine that in-device co-existence interference has occurred and may detect the in-device co-existence interference.

As yet still another example, when the transmission of signal y lasts a predetermined period of time, the terminal may detect that there is interference.

As yet still another example, in case the transmission of the signal y does not last but is repeated a predetermined period of time or more, the terminal may determine that interference occurs and may detect the interference.

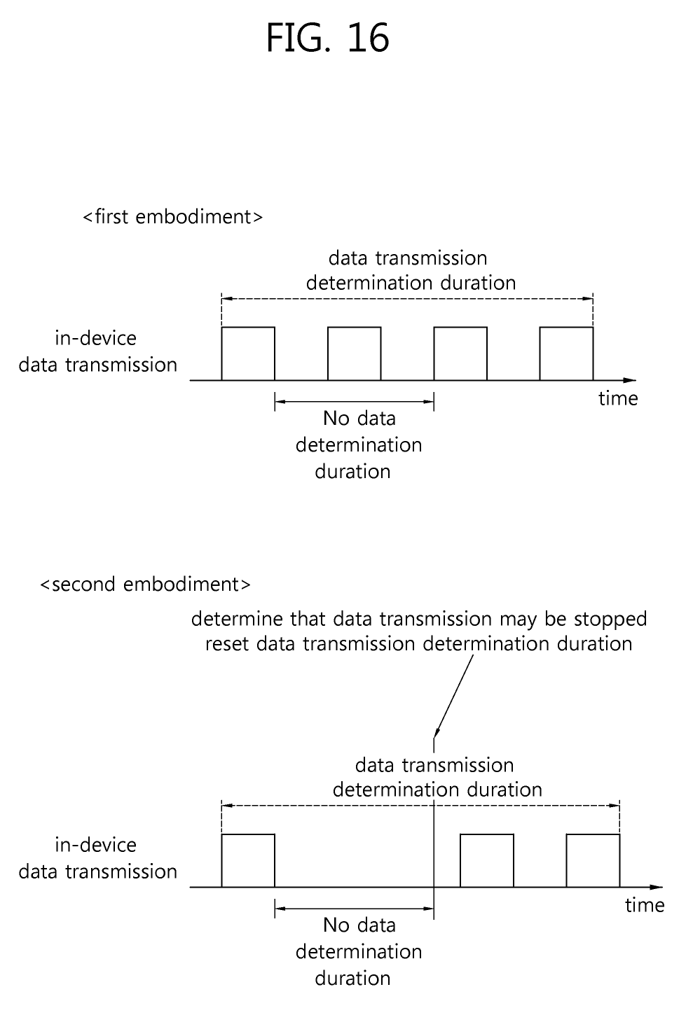

FIG. 16 illustrates an example where a terminal detects in-device co-existence interference using data transmission determination duration and no data determination duration. The terminal may previously set up the data transmission determination duration and no data determination duration and may detect in-device co-existence interference using the same.

Referring to FIG. 16, if during the data transmission determination duration no data transmission is performed within the no data determination duration, the terminal does not detect in-device co-existence interference (second embodiment). This is why if no signal is transmitted during a long time but interference is determined to occur, unnecessary procedures need to be conducted. Accordingly, in case the situation where no signal is transmitted continues during the no data determination duration or more, it is determined that the signal transmission is terminated. Then, the data transmission determination duration is reset. Thereafter, if a signal is newly transmitted, the transmission determination duration resumes.

On the contrary, if during the data transmission determination duration data is transmitted within the no data determination duration, it is determined that data transmission is maintained. If the data transmission continues during the data transmission determination duration, the terminal may detect in-device co-existence interference (first embodiment). That is, even though signal transmission does not last and temporarily stops on the way, if signal transmission resumes in a predetermined time (no data determination duration), the terminal determines that signal transmission is maintained.

As another example, co-existence interference may be detected using timers that respectively operate during the data transmission determination duration or no data determination duration.

As still another example, even when the terminal transmits signal u to the base station through another RF such as LTE RF or WiFi while receiving signal z from the base station through the ISM RF, the same in-device co-existence interference detection scheme as described above may apply as well. In-device co-existence interference may be detected using SINR and in-device co-existence interference may be detected using RSRP or RSRQ. In case, while receiving signal z through the ISM RF, the interference strength of signal u measured is larger than a predetermined threshold or the status where the interference strength of signal u is larger than a predetermined threshold continues during a predetermined period of time, the terminal may determine that in-device co-existence interference occurs and may detect the in-device co-existence interference. As such, when it is determined that the transmission of the LTE RF causes interference in such a manner to render reception over the ISM band difficult, the terminal may detect in-device co-existence interference. Further, in connection with FIG. 16, the transmission of data may be defined as the situation where the interference strength of signal u is larger than a predetermined threshold. In contrast, in case the interference strength of signal u is lowered to a threshold or less, it may be defined as the situation where data transmission is paused.

As another example, the terminal may detect in-device co-existence interference with respect to the strength of interference that has undergone filtering. The strength of in-device co-existence interference may be an interference-to-noise value measured for a part that is interfered by a hetero-type communication device or may be the interference strength itself. Since in-device co-existence interference may severely vary depending on whether data is transmitted to a hetero-type communication device, the interference strength that has undergone filtering may be used for detection. A simplest example of such filtering may be implemented in such a way that the interference strengths measured for each subframe are weighted summed. An example of weighted-sum filtering is the following equation:

Fₙ(1−a)·Fₙ₋₁+a·Mₙ [Equation 1]

Here, Fn is a filtered interference value, Fn−1 is an interference value filtered until the previous time, Mn is an interference value measured for the current subframe, and a is a weight. If the filtered interference strength is larger than a predetermined threshold, the terminal may detect in-device co-existence interference.

As another example, the terminal may detect in-device co-existence interference based on the situation where the strength of in-device co-existence interference continues during a predetermined period of time. This detects in-device co-existence interference based on the situation where the interference strength continues and lasts in a similar way to the data transmission described above in connection with FIG. 16.

However, a difference from the scheme illustrated in FIG. 16 is that when the strength of interference measured for a specific subframe is larger than a predetermined threshold may be considered to be an event such as data transmission. Assume that an event where the interference strength goes beyond the threshold is a “strong interference occurrence event” and an event where the interference strength goes under the threshold is a weak interference occurrence event. The data transmission corresponds to the strong interference occurrence event, and the section where no data transmission occurs corresponds to the weak interference occurrence event. Here, the concept of the time may be construed as the number of samples in light of the concept of measured samples.

As another example, the terminal may determine whether to detect in-device co-existence interference based on the situation where no in-device co-existence interference is detected during a predetermined period of time. That is, in-device co-existence interference not occurring is determined using no transmission determination duration (or “no transmission determination continuing section”). The no transmission determination duration is a period of time that should continue after the transmission is paused to result in the conclusion that meaningful transmission that would cause in-device co-existence interference would not occur. The no transmission determination duration is distinguished from the data transmission determination duration that should continue after the data transmission is initiated to result in the conclusion that meaningful data transmission has occurred that would cause in-device co-existence interference.

Specifically, in case, while receiving signal x from the base station through the LTE RF, the terminal transmits signal y through another RF such as WiFi, if the transmission of signal y does not continue during corresponding duration, the terminal may determine that no in-device co-existence interference occurs. At this time, the transmission of signal y may mean data transmission itself, or may mean when the interference strength measured by the LTE RF is larger than a threshold or when the SINR value measured by the LTE RF is smaller than a threshold.

As another example, the terminal may determine the data transmission, which does not last during a predetermined time, as insufficient to cause in-device co-existence interference, and thus, may not determine it as in-device co-existence interference. This is referred to as “no transmission is determined.” In case the situation where no data transmission occurs is maintained during the no transmission determination duration, the terminal may determine that there is no in-device co-existence interference.

Specifically, to be sensed as an interference signal, an interference signal should be transmitted during the data transmission determination duration. In case a signal is detected during less than the data transmission determination duration, it is considered no data transmission. In case a signal is not detected during the no transmission determination duration, it is determined as no transmission, and may be determined as no interference signal being generated. No transmission of signal y may mean that data transmission itself does not occur or may be interpreted as when the interference strength on the side of the LTE is measured to be smaller than a threshold or when the SINR value measured on the side of the LTE is larger than a threshold. Further, if a signal is sensed that lasts during the data transmission determination duration or more before the no transmission determination duration is expired, it may be determined as the data transmission being continued. Accordingly, since an interference strength is determined to occur, the terminal detects in-device co-existence interference. Thereafter, if the transmission of the signal causing in-device co-existence interference is stopped, the no transmission determination duration is reset so that a no transmission determination duration-related timer restarts.

As another example, when an handover occurs in the ISM band so that the interference affecting the LTE band does not take place any longer, it may be determined that in-device co-existence interference has gone and the in-device co-existence interference might be not detected.

Meanwhile, in FIG. 9, a process may be provided that, although occurrence of in-device co-existence interference has been detected, may prevent interference information from being transferred to the base station. This is a scheme to prevent the process of in-device co-existence interference, which varies, from happening too often. In a simple embodiment, a prohibit timer may be provided so that although, after occurrence of in-device co-existence interference is detected once and interference information is transferred from the terminal to the base station, the terminal detects in-device co-existence interference once more in the prohibit timer, the terminal may not transfer interference information. Accordingly, interference information that is generated due to occurrence of in-device co-existence interference may be prevented from being transferred to the base station too frequently. The prohibit timer may also be referred to as inhibit timer or cutoff timer.

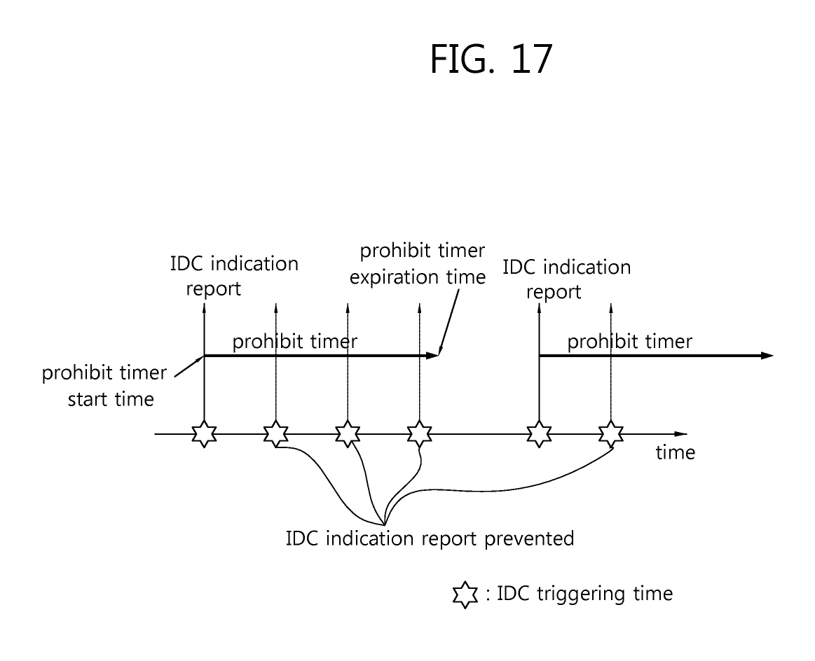

FIG. 17 is a view illustrating a specific operation of a prohibit timer according to the present invention.

Referring to FIG. 17, if occurrence of in-device co-existence interference is detected so that interference information is transferred from the terminal to the base station, the prohibit timer starts. Here, the “prohibit timer starts” means that an internal time value preset in the prohibit timer starts to be reduced as time goes by. For example, the internal time value of the prohibit timer is set as 1000 subframes, the internal time value of the prohibit timer are reduced by one subframe per subframe from the start of the prohibit timer.

Before the internal time value of the prohibit timer is gradually reduced and finally becomes 0, although in-device co-existence interference is detected (or although IDC triggering occurs), whether in-device co-existence interference occurs is not indicated/transmitted to the base station by the terminal. Here, the time point when the internal time value of the prohibit timer becomes 0 is referred to as the time point when the prohibit timer expires.

In other words, before the time point when the prohibit timer expires, although occurrence of in-device co-existence interference is triggered, the terminal may send a report of indicating that in-device co-existence interference occurs to the base station. Accordingly, the terminal may send a report of indicating that in-device co-existence interference occurs to the base station according to IDC triggering after the prohibit timer expires.

By way of example, set values of the prohibit timer including the internal time value of the prohibit timer may be determined by internal variables of the terminal. As another example, the prohibit timer set values may be sent from the base station to the terminal by signaling. At this time, the signaling may be RRC (Radio Resource Control) signaling, MAC (Media Access Control) signaling, or PDCCH (Physical Downlink Control Channel) signaling. Here, the RRC signaling may be performed cell-specifically through a system information message, or a terminal-specific (UE-specific) value may be signaled to each terminal terminal-specifically. The system information message may be broadcast to all the terminals in a corresponding cell.

As an example of the RRC signaling, e.g., internal time value of the prohibit timer may be signaled using one variable in the RRC connection reconfiguration message. Further, the signaling may be conditionally determined according to the terminal. Here, “conditionally determined” means that the base station may performing signaling only on the terminals that have been already determined to be able to transmit an in-device co-existence interference indicator to the base station. At this time, as an example of the method of previously determining and informing that the terminal may transmit a report indicating in-device co-existence interference to the base station, the terminal may inform the base station that the terminal may transmit a report indicating in-device co-existence interference by transmitting terminal capability information to the base station.

Specifically, the internal time value of the prohibit timer may be transmitted using a radio resource configuration dedicated information element that is a variable included in the RRC connection reconfiguration information element of the RRC connection reconfiguration message. The radio connection configuration dedicated information element includes, as a variable, an in-device co-existence interference configuration variable. Here, the radio connection configuration dedicated information includes what is determined with the internal time value of the prohibit timer being determined terminal-specifically, and this includes a different timer value being set for each terminal.

The in-device co-existence interference configuration variable includes an in-device co-existence interference indication prohibit timer variable that may include rf1, rf2, rf4, . . . , and rf4096 each of which represents a unit of radio frame. For example, rf1 may mean one radio frame (10 ms), rf2 two subframes (20 ms), rf4 four subframes (40 ms), . . . , rf4096 4096 subframes (40960 ms). As another example, instead of rf1, rf2, rf4, . . . , rf4096, subframe units, sf1, sf2, sf4, . . . , sf4096, may be used as in-device co-existence interference indication prohibit timer variables. At this time, sf1 may mean one subframe (1 ms), sf2 two subframes (2 ms), sf4 four subframes (4 ms), and sf4096 4096 subframes (4096 ms). This is merely an example, and the internal time value of the prohibit timer may be set by various methods.

Meanwhile, as another example of RRC signaling, cell-specific signaling may be possible. At this time, a system information block type2 information element may be used. The system information block type2 information element may include a radio resource configuration common variable, and an information element of the radio resource configuration common variable may include an in-device co-existence interference configuration common variable. The in-device co-existence interference configuration common variable includes an in-device co-existence interference indication prohibit timer variable, and through this, set values such as the internal time value of the prohibit timer may be signaled.

Here, in the cell-specific signaling, as a timer value commonly applicable to terminals in a cell, the same timer value applies. Accordingly, a common timer value is applied to the terminals in the cell, but it includes the probability that the terminals may sense interference at different times from each other.

As an example of RRC signaling, an RRC connection reconfiguration message is as follows. This is terminal-specific signaling.

TABLE 2
--ASN1START
RRCConnectionReconfiguration ::=SEQUENCE {
rrc-TransactionIdentifierRRC-TransactionIdentifier,
criticalExtensionsCHOICE {
c1CHOICE{
rrcConnectionReconfiguration-r8RRCConnectionReconfiguration-r8-IEs,
spare7 NULL,
spare6 NULL, spare5 NULL, spare4 NULL,
spare3 NULL, spare2 NULL, spare1 NULL
},
criticalExtensionsFutureSEQUENCE { }
}
}
RRCConnectionReconfiguration-r8-IEs ::= SEQUENCE {
measConfigMeasConfigOPTIONAL,-- Need ON
mobilityControlInfoMobilityControlInfoOPTIONAL,-- Cond HO
dedicatedInfoNASListSEQUENCE (SIZE(1..maxDRB)) OF
DedicatedInfoNASOPTIONAL,-- Cond nonHO
radioResourceConfigDedicatedRadioResourceConfigDedicated-
OPTIONAL, -- Cond HO- toEUTRA
securityConfigHOSecurityConfigHOOPTIONAL,-- Cond HO
nonCriticalExtensionRRCConnectionReconfiguration-v890-IEs-
OPTIONAL
}

Here, the radio connection configuration dedicated information element is as follows.

TABLE 3
--ASN1START
RadioResourceConfigDedicated ::=SEQUENCE {
srb-ToAddModListSRB-ToAddModListOPTIONAL, -- Cond HO-Conn
drb-ToAddModListDRB-ToAddModListOPTIONAL, --
Cond HO-toEUTRA
drb-ToReleaseListDRB-ToReleaseListOPTIONAL, -- Need ON
mac-MainConfigCHOICE {
explicitValueMAC-MainConfig,
defaultValueNULL
} OPTIONAL,-- Cond HO-toEUTRA2
sps-ConfigSPS-Config OPTIONAL,-- Need ON
physicalConfigDedicatedPhysicalConfigDedicatedOPTIONAL,
-- Need ON
...,
idc-ConfigIDC-ConfigOPTIONAL,-- Need ON
[[ rlf-TimersAndConstants-r9RLF-TimersAndConstants-r9
OPTIONAL-- Need ON ]]
[[ measSubframePatternPCell-r10MeasSubframePatternPCell-
r10OPTIONAL-- Need ON ]]
}
IDC-Config:: = SEQUENCE {
idcInidicationProhibit-TimerENUMERATED {
rf1, rf2, rf4, rf8, rf16, rf32, rf64, rf128,
rf256, rf512, rf1024, rf2048, rf4096 }
}

As another example of RRC signaling, the system information block type2 information element is as follows. This is cell-specific signaling.

TABLE 4
-- ASN1START
SystemInformationBlockType2 ::=SEQUENCE {
ac-BarringInfoSEQUENCE {
ac-BarringForEmergencyBOOLEAN,
ac-BarringForMO-SignallingAC-BarringConfigOPTIONAL,-- Need OP
ac-BarringForMO-DataAC-BarringConfigOPTIONAL-- Need OP
} OPTIONAL,-- Need OP
radioResourceConfigCommonRadioResourceConfigCommonSIB,
ue-TimersAndConstantsUE-TimersAndConstants,
freqInfoSEQUENCE {
ul-CarrierFreqARFCN-ValueEUTRAOPTIONAL,-- Need OP
ul-BandwidthENUMERATED n6, n15, n25, n50, n75, n100
OPTIONAL,-- Need OP
additionalSpectrumEmissionAdditionalSpectrumEmission
},
mbsfn-SubframeConfigListMBSFN-SubframeConfigListOPTIONAL,
-- Need OR
timeAlignmentTimerCommonTimeAlignmentTimer,
...,
lateNonCriticalExtensionOCTET STRINGOPTIONAL,-- Need OP
[[ssac-BarringForMMTEL-Voice-r9AC-BarringConfigOPTIONAL,
-- Need OP
ssac-BarringForMMTEL-Video-r9AC-BarringConfigOPTIONAL--
Need OP ]],
[[ac-BarringForCSFB-r10AC-BarringConfigOPTIONAL-- Need OP ]]
}
AC-BarringConfig ::=SEQUENCE {
ac-BarringFactorENUMERATED {
p00, p05, p10, p15, p20, p25, p30, p40,
p50, p60, p70, p75, p80, p85, p90, p95},
ac-BarringTimeENUMERATED {s4, s8, s16, s32, s64, s128, s256, s512},
ac-BarringForSpecialACBIT STRING (SIZE(5))
}
MBSFN-SubframeConfigList ::= SEQUENCE (SIZE
(1..maxMBSFN-Allocations)) OF MBSFN-SubframeConfig
-- ASN1STOP

The radio connection configuration common information element is as follows.

TABLE 5
-- ASN1START
RadioResourceConfigCommonSIB ::=SEQUENCE {
rach-ConfigCommonRACH-ConfigCommon,
bcch-Config BCCH-Config,
pcch-Config PCCH-Config,
prach-ConfigPRACH-ConfigSIB,
pdsch-ConfigCommonPDSCH-ConfigCommon,
pusch-ConfigCommonPUSCH-ConfigCommon,
pucch-ConfigCommonPUCCH-ConfigCommon,
soundingRS-UL-ConfigCommonSoundingRS-UL-ConfigCommon,
uplinkPowerControlCommonUplinkPowerControlCommon,
ul-CyclicPrefixLengthUL-CyclicPrefixLength,
...,
idc-ConfigCommonIDC-ConfigCommonOPTIONAL-- Need ON
[[uplinkPowerControlCommon-v1020UplinkPowerControlCommon-
v1020OPTIONAL-- Need OR ]]
IDC-ConfigCommon:: = SEQUENCE {
idcInidicationProhibit-TimerENUMERATED {
rf1, rf2, rf4, rf8, rf16, rf32, rf64, rf128,
rf256, rf512, rf1024, rf2048, rf4096}
}

Subsequent to step S900, the terminal, if in-device co-existence interference is detected, transmits assistance information for mitigating, avoiding or removing interference to the base station (S905). In case the situation where in-device co-existence interference occurs lasts long or a low transmission rate is detected, the terminal may request that the base station be to perform interference adjustment based on the FDM scheme. Such request is implemented by assistance information. Hereinafter, the operations of reducing, avoiding, and removing interference are collectively referred to as interference adjustment (or interference coordination). The assistance information is information necessary for adjusting in-device co-existence interference based on the FDM scheme. The base station may consider the assistance information as a request for interference adjustment from the terminal. The assistance information may be a message generated at the RRC (Radio Resource Control) layer or MAC (Medium Access Control) layer or may be physical layer signaling.

By way of example, the assistance information includes a measurement result. That is, the assistance information includes measurement results such as SINR, RSRP, or RSRQ. As another example, the assistance information includes an indicator indicating the need of avoiding in-device co-existence interference based on the FDM scheme, together with the measurement results. As still another example, the assistance information may be information for supporting interference coordination based on the FDM scheme or may be information representing that TDM scheme-based interference coordination is impossible. Here, in case the assistance information means that TDM scheme-based interference coordination is impossible, the assistance information may be a separate indicator that indicates TDM impossibility or may be pattern information defining a blank transmission region for all the resources.

The RSRQ is obtained as an average value over a specific period (e.g., 200 ms). Since in-device co-existence interference is irregular interference that occurs between different wireless systems, the average value may be sharply changed depending on the devices' circumstances. Accordingly, the form of the assistance information reported from the terminal under the in-device co-existence situation may differ from assistance information of non in-device co-existence interference. Assistance information reported under the in-device co-existence situation may be classified into the following four types:

(1) Assistance information including measurement results reflecting in-device co-existence interference: in this type of assistance information, the measurement result itself reflects in-device co-existence interference. For example, assume that downlink component carriers CC1, CC2, and CC3 are configured in the terminal and that in-device co-existence interference occurs in CC1. At this time, the RSRQs of CC1, CC2, and CC3 are as shown in Table 6:

TABLE 6

| CC | RSRQ |
|---|---|
| CC1 | $\frac{{S}_{1}}{{I}_{1} + {N}_{1}}$ |
| CC2 | $\frac{{S}_{2}}{{I}_{2} + {N}_{2}}$ |
| CC3 | $\frac{{S}_{3}}{{I}_{3} + {N}_{3}}$ |

Referring to Table 6, Sn is the strength of a received signal of CCn, In is the strength of an interference signal acting in CCn, and Nn is the strength of noise acting in CCn. Here, if the strength of in-device co-existence interference occurring in CC1 is I′, the measurement results included in the assistance information are as shown in Table 7:

TABLE 7

| CC | Measurement result |
|---|---|
| CC1 | $\frac{{S}_{1}}{{I}_{1} + {I}^{′} + {N}_{1}}$ |
| CC2 | $\frac{{S}_{2}}{{I}_{2} + {N}_{2}}$ |
| CC3 | $\frac{{S}_{3}}{{I}_{3} + {N}_{3}}$ |

Referring to Table 7, a difference from Table 6 is that I′ is added to the denominator of each measurement result.

(2) Assistance information including measurement results in which RSRQ and in-device co-existence interference are separated: The interference strengths, in addition to RSRQs, are considered to be measurement results. In such case, the measurement results may be shown as in Table 8:

TABLE 8

| CC | Measurement result |
|---|---|
| CC1 | $\frac{{S}_{1}}{{I}_{1} + {N}_{1}} , {I}^{′}$ |
| CC2 | $\frac{{S}_{2}}{{I}_{2} + {N}_{2}}$ |
| CC3 | $\frac{{S}_{3}}{{I}_{3} + {N}_{3}}$ |

Referring to Table 8, the measurement result for CC1 includes both S₁/(I₁+N₁) [symbol] I′. That is, the measurement result included in the assistance information has the form in which I′ is reported in addition to the existing RSRQ which is reported.

(3) Assistance information including a usable band indicator and a non-usable band indicator: A CC in which in-device co-existence interference occurs is a frequency band that is not usable in light of the terminal. On the contrary, a CC in which no in-device co-existence interference occurs is a usable frequency band in light of the terminal. Accordingly, the terminal may configure assistance information that include a usable band indicator indicating a CC having a usable frequency band and a non-usable band indicator indicating a CC having a non-usable frequency band. In Table 8, the non-usable band indicator is {1}, and the usable band indicator is {2,3}.

(4) Assistance information including the strength of in-device co-existence interference: If in-device co-existence interference occurs, the terminal configures assistance information to display the strength of the in-device co-existence interference for the corresponding CC. For example, the strength of the in-device co-existence interference={I′, 0, 0}, which are mapped with CC1, CC2, and CC3, respectively, from left to right. Or, the terminal may also configure assistance information in such a manner as informing information on a frequency band itself, such as a usable region and a non-usable region in an actual frequency band.

Turning back to step S905, the base station determines whether to perform in-device co-existence interference coordination according to the FDM scheme based on assistance information (S910). The following determination references may apply to determine whether to perform interference coordination. By way of example, in case assistance information has the form of having a usable band indicator and a non-usable band indicator as (4) above, the base station may determine whether to perform interference coordination through the capacity of available resources in an avoiding band. A band indicated by the usable band indicator may avoid in-device co-existence interference, and thus, is referred to as avoiding band. The base station calculates the capacity of available resources in the avoiding band. The capacity of available resources may mean the amount of usable radio resources except for radio resources allocated by the base station for other terminals in the avoiding band. If the capacity of available resources in the avoiding band is not enough, the base station may not accept shift (mobility) of the terminal according to the FDM scheme. In contrast, if the capacity of available resources in the avoiding band is enough, the base station may accept shift (mobility) of the terminal to the avoiding band and may thus perform interference coordination.

As another example, the base station may determine whether to perform interference coordination based on measurement results such as RSRP or RSRQ. Shift to a frequency band having a low RSRP or RSRQ is not a preferable situation in light of the base station and terminal. Accordingly, although an avoiding band has a capacity of available resources from the point of view of determination of the capacity of available resources and priority of RSRP/RSRQ, if the RSRQ or RSRQ is too low, the base station may not accept shift of the terminal to the avoiding band.

After determining whether to perform interference coordination, the base station transmits response information to the terminal (S915). The response information may be information meaning accepting or rejecting coordination of in-device co-existence interference.

In case the response information means accept, the procedure of accepting interference coordination by the base station may be conducted by one of a cell reconfiguration procedure, a handover procedure, frequency shifting and frequency shaping.

As an example of response information meaning accept, the response information may be a cell reconfiguration message in a cell reconfiguration procedure. The cell reconfiguration procedure is a procedure for reconfiguring a cell or frequency band so that no interference occurs. When receiving the cell reconfiguration message from the base station, the terminal may consider it as the request for coordination of in-device co-existence interference being accepted. For example, if CC1 and CC2 are configured in the terminal and in-device co-existence interference is detected in CC1, the terminal may transmit assistance information for removing interference to the base station. At this time, if the CCs configured in the terminal are reconfigured as CC2 and CC3 by the cell reconfiguration procedure, CC1 where interference occurs is left out, so that the in-device co-existence interference does not occur any longer. The terminal may be aware that the request for removing interference has been accepted from the cell reconfiguration procedure.

As another example of response information meaning accept, the response information may be a handover command message in a handover procedure. The handover procedure is a procedure for handing over the terminal so that no interference occurs. When receiving a handover command message from the base station, the terminal may consider it as the request for coordination of in-device co-existence interference being accepted. For example, if CC1 configured in the terminal is a primary serving cell (Pcell) and in-device co-existence interference is detected in CC1, the terminal may transmit assistance information for removing interference to the base station. At this time, if the primary serving cell is changed to CC2 by a handover procedure, the in-device co-existence interference does not occur any longer. The terminal may be aware that the request for removing interference has been accepted from the handover procedure.

Here, the primary serving cell refers to a serving cell that is used for transferring NAS information and configuring security when carrier aggregation applies. According to the LTE Rel-10, the physical uplink control channel (PUCCH) is present in the primary serving cell. Further, a cell is defined as consisting of a pair of one DL CC and one UL CC or one DL CC.

As another example of response information meaning accept, the response information may be an accepting indicator regarding performing interference coordination. The accepting indicator may be transmitted through an RRC layer message, an MAC layer message, or a physical layer PDCCH (Physical Downlink Control Channel). Or, the accepting message may be a new type of control message, and may be a message that is transmitted, piggybacked on other response information.

As still another example of response information meaning accept, the response information may be a frequency shifting indicator indicating shifting a band where interference occurs by a predetermined frequency offset or may be a frequency shaping indicator indicating shaping part of a band where interference occurs.

Hereinafter, such a series of assistance information or response information used in a procedure of adjusting in-device co-existence interference is collectively referred to as information regarding in-device co-existence interference.

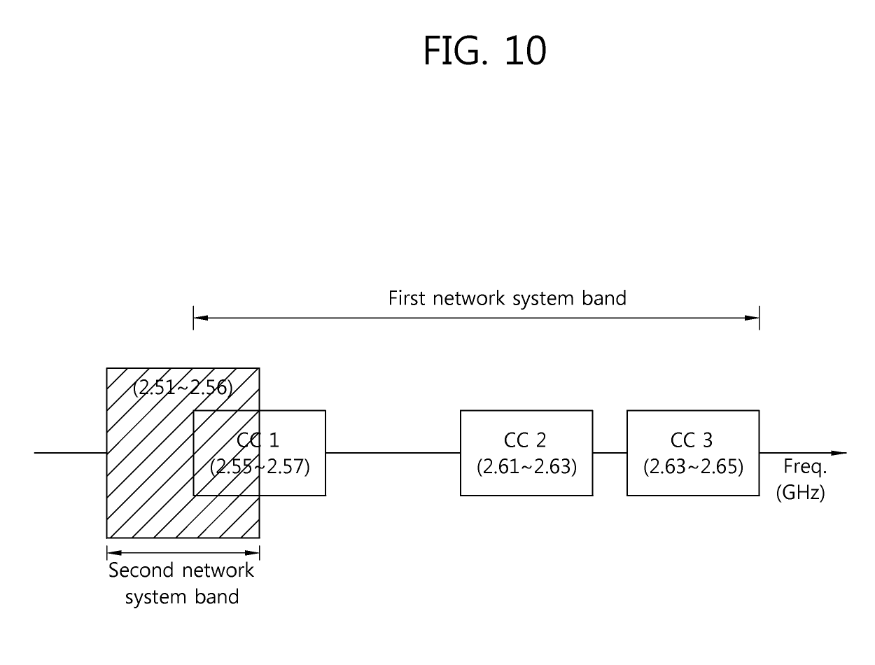

FIGS. 10 to 12 are views illustrating a method of performing coordination of in-device co-existence interference by frequency shifting or shaping according to an embodiment of the present invention.

Referring to FIG. 10, in a first network system, the band of CC1 is 2.55 to 2.57 GHz, the band of CC2 is 2.61 to 2.63 GHz, and the band of CC3 is 2.63 to 2.65 GHz. The frequency band of a second network system is 2.51 to 2.56 GHz that overlaps the band of CC1 over the band of 2.55 to 2.56 GHz. Accordingly, in-device co-existence interference may occur in the overlapping band. Here, the first network system may be a 3GPP (3rd Partnership Project) LTE (Long Term Evolution) system, and the second network system may be a Bluetooth or WiFi system. If the terminal sends assistance information to the base station due to the in-device co-existence interference, the base station transmits information indicating accept or reject to the terminal.

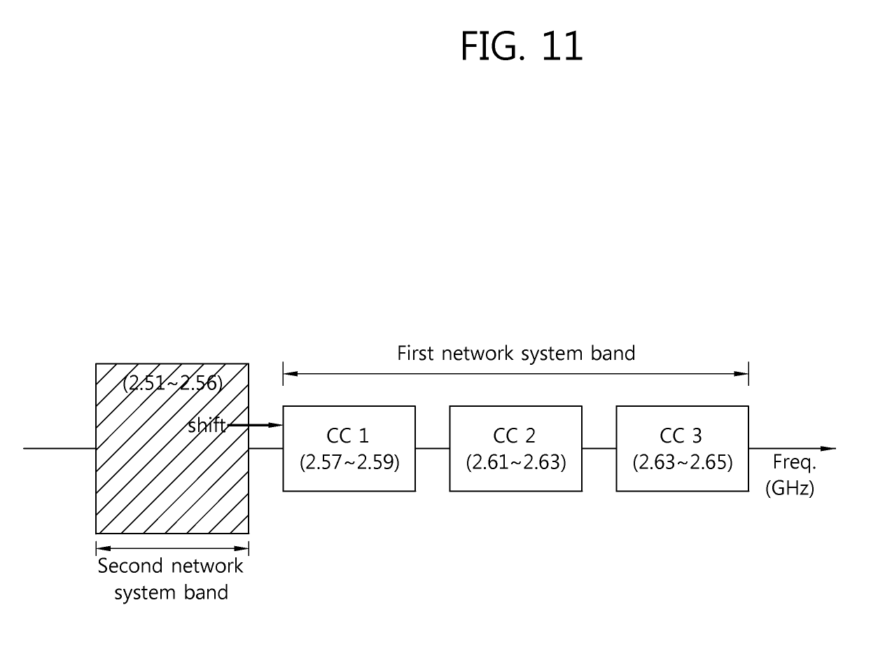

As an example, the base station may shift a band where interference occurs and this is referred to as frequency shifting. In other words, CC1 of the first network system, where interference occurs, is shifted by an offset of 0.02 GHz as shown in FIG. 11. Accordingly, the band of CC1 is changed to 2.57 to 2.59 GHz, and the in-device co-existence interference between CC1 and the second network system may be removed. Meanwhile, the base station may inform the terminal of being to perform frequency shifting with response information, and this is referred to as “frequency shifting indicator.” This may be an RRC message, an MAC message or physical layer signaling.

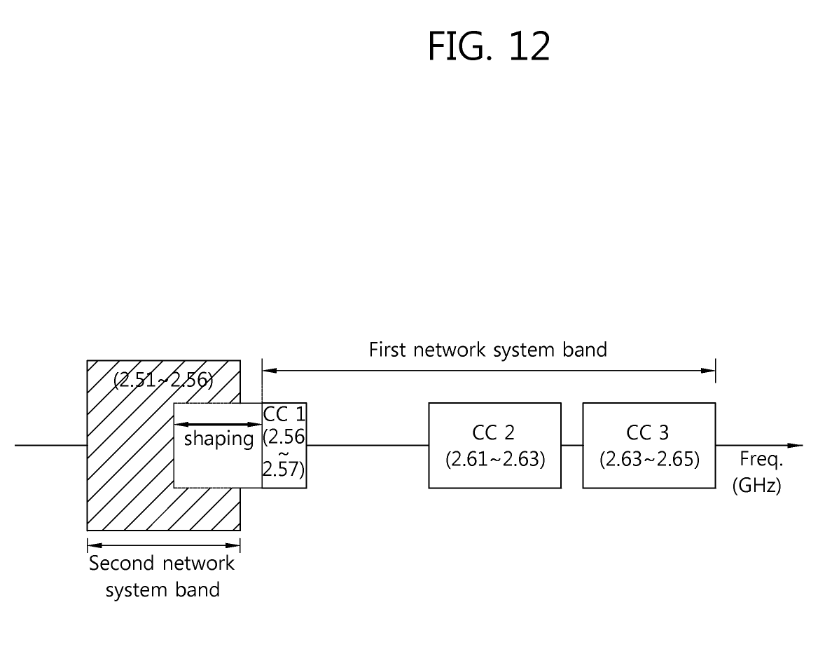

As another example, the base station may shape a band where interference occurs and this is referred to as frequency shaping. In other words, the base station cuts off part of CC1, which causes interference together with the band of the second network system, by 0.01 GHz as shown in FIG. 12. Here, cutting off part of a frequency band may mean changing a physical filtering characteristic (e.g., number of tabs) or may mean the base station restrictively scheduling resources on the corresponding band. That is, the resource allocation for the terminal is limited to Fx band.

By frequency shaping, the band of CC1 is changed to 2.56 to 2.57 GHz, and the in-device co-existence interference between CC 1 and the second network system may be removed. Here, . . .

On the other hand, the base station being to perform frequency shaping is reported to the terminal with response information, and this is referred to as frequency shaping indicator. This may be an RRC message, an MAC message or physical layer signaling.

Turning back to step S915 of FIG. 9, in case the response information is information meaning reject, a procedure of rejecting interference coordination by the base station may be performed by one of the following three types.

(1) transmission of a reject indicator: The base station may perform a procedure of rejecting a request for interference coordination by transmitting a reject indicator to the terminal as response information. The reject indicator may be transmitted through an RRC message, an MAC message or a physical layer PDCCH. Or, it may be a new type of indicator that is different from the existing messages.

(2) expiration of timer: If the terminal drives the timer and then fails to receive response information from the base station until the timer expires, the terminal may recognize it as rejecting a request for interference coordination. Here, the response information may mean accept or reject. If receiving no response information whether it is accept or reject, the terminal considers it as a rejection process being performed, and proceeds with subsequent procedures.

(3) indicating other types of interference coordination: If the terminal receives a message indicating a different type of interference coordination than the response information predicted by the terminal, then the terminal may recognize that an FDM scheme-based interference coordination rejecting procedure is carried out. This is to, in light of the base station, suggest an alternative way (e.g., TDM scheme-based interference coordination) to address the circumstance where the FDM scheme-based interference coordination cannot be done. For example, if the terminal receives a message indicating TDM scheme-based interference coordination, the terminal may recognize that although the FDM scheme-based interference coordination has been rejected, TDM scheme-based interference coordination is to be conducted. The indicator indicating other types of interference coordination may be an RRC message, an MAC message or physical layer PDCCH. Or, it may be done in the form of signaling that transfers to the terminal a TDM pattern considering that other types of interference coordination itself are suitable for the base station.

The above-suggested rejecting procedures may be performed separately or independently or some thereof may be performed together, or all of the rejecting procedures may be carried out.

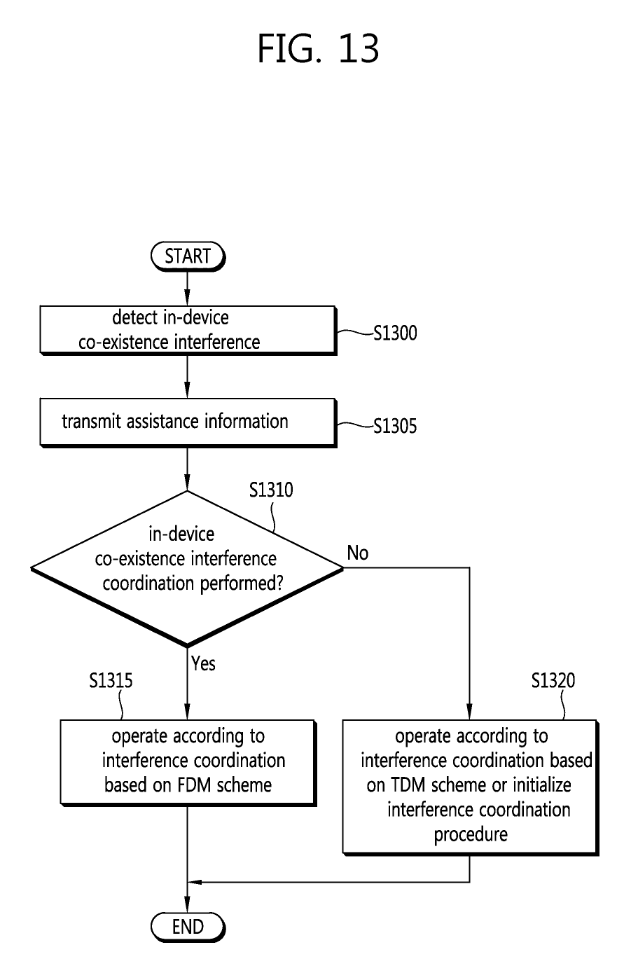

FIG. 13 is a flowchart illustrating a method of transmitting information regarding in-device co-existence interference by a terminal according to an embodiment of the present invention.

Referring to FIG. 13, the terminal detects in-device co-existence interference (S1300). If in-device co-existence interference is detected, the terminal transmits assistance information to the base station (S1305). The assistance information is a sort of information requesting interference coordination and includes parameters necessary for adjusting interference based on an FDM scheme. By way of example, the assistance information includes measurement results. That is, the assistance information includes measurement results such as SINR, RSRP or RSRQ. An another example, the assistance information includes an indicator indicating that avoiding in-device co-existence interference is needed based on the FDM scheme, together with the measurement results. The assistance information may be a message generated at the RRC (Radio Resource Control) layer or MAC (Medium Access Control) layer or may be physical layer signaling. However, the terminal sends out the assistance information in case a prohibit timer expires of preventing the interference information from being transferred during a predetermined period of time. After through the prohibit timer occurrence of in-device co-existence interference is detected once and interference information is transmitted from the terminal to the base station, before the prohibit timer expires, the terminal, even when in-device co-existence interference is detected once more, cannot transfer interference information to the base station. By doing so, too much interference information due to occurrence of in-device co-existence interference may be prevented from being transferred to the base station.

The terminal determines whether to perform interference coordination (S1310). Whether an interference coordination procedure is performed may be determined as follows. By way of example, when receiving response information indicating accepting performing interference coordination in response to the assistance information transmitted from the terminal, the terminal may be aware that an interference coordination procedure is to be conducted. At this time, the response information is response information in one procedure among a cell reconfiguration procedure, a handover procedure, frequency shifting, and frequency shaping.

As another example, in case the terminal receives an indicator indicating a type of interference coordination different from the FDM scheme-based interference coordination.

As another example, if the terminal fails to receive response information that indicates accepting performing interference coordination after the timer is driven and before the timer expires, the terminal may be aware that the request for interference coordination has been rejected.

The terminal may receive from the base station prohibit timer setting values before transmitting the assistance information (not shown in the drawings). This is why the terminal may transmit assistance information based on the prohibit timer. At this time, signaling may be RRC signaling, MAC signaling, or signaling by PDCCH. Here, the RRC signaling may be performed cell-specifically through a system information message or a terminal-specific value may be signaled terminal-specifically to each terminal. The system information message is a message broadcast to all the terminals in the corresponding cell.

Here, receiving the prohibit timer setting values before the assistance information is transmitted may include it being able to be received upon an RRC connection reconfiguration procedure.

Further, the terminal may receive the timer value during a procedure of receiving a response message for interference coordination from the base station after transmitting assistance information. That is, the terminal may receive a timer value determined cell-dedicatedly or terminal-dedicatedly for driving the prohibit timer through the response information for interference coordination.

As an example of RRC signaling, one variable included in the RRC connection reconfiguration message may be used to signal, e.g., internal time values of the prohibit timer. That is, the base station may perform signaling only on terminals that have been previously determined to be able to transmit an in-device co-existence interference indicator to the base station. At this time, in an exemplary method of previously determining and informing that the terminal may transmit a report indicating in-device co-existence interference to the base station, the terminal may inform that the terminal may transmit a report indicating in-device co-existence interference by transmitting terminal capability information to the base station.

If the request for interference coordination is determined to have been accepted, the terminal operates according to FDM scheme-based interference coordination (S1315).

If the request for interference coordination is determined to have been rejected, the terminal initializes an FDM scheme-based interference coordination procedure or performs TDM scheme-based interference coordination (S1320).

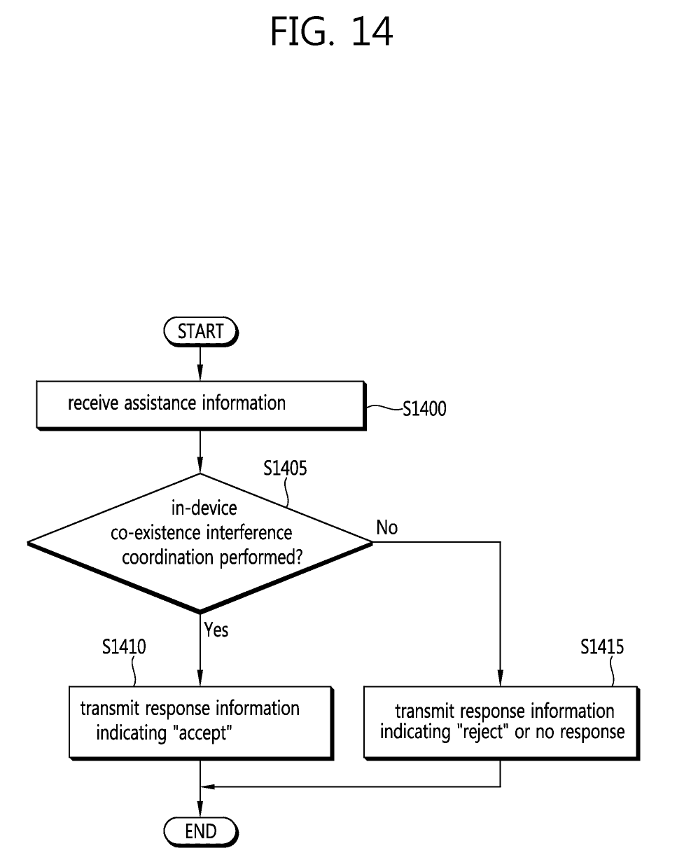

FIG. 14 is a flowchart illustrating a method of transmitting information regarding in-device co-existence interference by a base station according to an embodiment of the present invention.

Referring to FIG. 14, the base station receives assistance information from the terminal (S1400). The assistance information provides information necessary for adjusting in-device co-existence interference based on an FDM scheme. Accordingly, the base station determines whether coordination of in-device co-existence interference may be performed according to the received assistance information (S1405). The following are references for determination.

As an example, the base station may determine whether to perform interference coordination through the capacity of available resources in an avoiding band. For this purpose, the base station may calculate the capacity of available resources in the avoiding band and may determine whether the capacity of available resources in the avoiding band is sufficient. If the capacity of available resources in the avoiding band is not enough, the base station would not accept a shift of the terminal to the avoiding band according to the FDM scheme. On the contrary, if the capacity of available resources in the avoiding band is enough, the base station may perform interference coordination by accepting a shift (mobility) of the terminal to the avoiding band.

As another example, the base station may determine whether to perform an interference coordination operation based on measurement results such as RSRP or RSRQ. A shift to a frequency band having low RSRP or RSRQ may be not preferable in light of the base station and the terminal. Accordingly, from the point of view of determination of the capacity of available resources and priority of RSRP/RSRQ, despite the avoiding band in which there is capacity of available resources, if the RSRP or RSRQ is too low, the base station cannot accept a shift of the terminal to the avoiding band.

If the coordination of in-device co-existence interference is determined to be possible according to the above-described determination references, the base station transmits response information meaning accept to the terminal (S1410). Here, the response information meaning accept may include any one of a cell reconfiguration message, a handover message, a frequency shift indicator, and a frequency shaping indicator.

On the contrary, if the coordination of in-device co-existence interference is determined to be impossible according to the above-described determination references, the base station transmits response information meaning reject to the terminal (S1415). Here, the response information meaning reject may be a message ordering interference coordination based on a scheme other than the FDM scheme, such as a TDM scheme or may be an NACK message indicating reject. Or, the base station may send no response to the assistance information, i.e., may stop transmission of the response information itself.

Before receiving assistance information, the base station may signal prohibit timer setting values (or internal time value of the prohibit timer) to the terminal (not shown in the drawings). This is why the terminal may transmit assistance information based on the prohibit timer. At this time, the signaling may be RRC signaling, MAC signaling, or signaling by PDCCH. Here, the RRC signaling may be performed cell-specifically through a system information message or a terminal-specific value may be signaled terminal-specifically to each terminal. The system information message is a message broadcast to all the terminals in the corresponding cell.

Here, the base station may configure a timer value for driving the prohibit timer and transmit it to the terminal before receiving the assistance information, i.e., upon a procedure of reconfiguring RRC connection with the terminal.

Further, the base station may transmit the timer value together with the response message for interference coordination corresponding to the assistance information received from the terminal. That is, in addition to the response information for interference coordination, a timer value determined terminal-dedicatedly or cell-dedicatedly for driving the prohibit timer may be transmitted.

As an example of RRC signaling, one variable in the RRC connection reconfiguration message may be used to signal, e.g., the internal time value of the prohibit timer. Further, the signaling may be conditionally determined according to the terminal. That is, the base station may perform signaling only on terminals that have been previously determined to be able to transmit an in-device co-existence interference indicator to the base station. At this time, in an exemplary method of previously determining and informing that the terminal may transmit a report indicating in-device co-existence interference to the base station, the terminal may inform the base station that the terminal may transmit a report indicating in-device co-existence interference by transmitting terminal capability information.

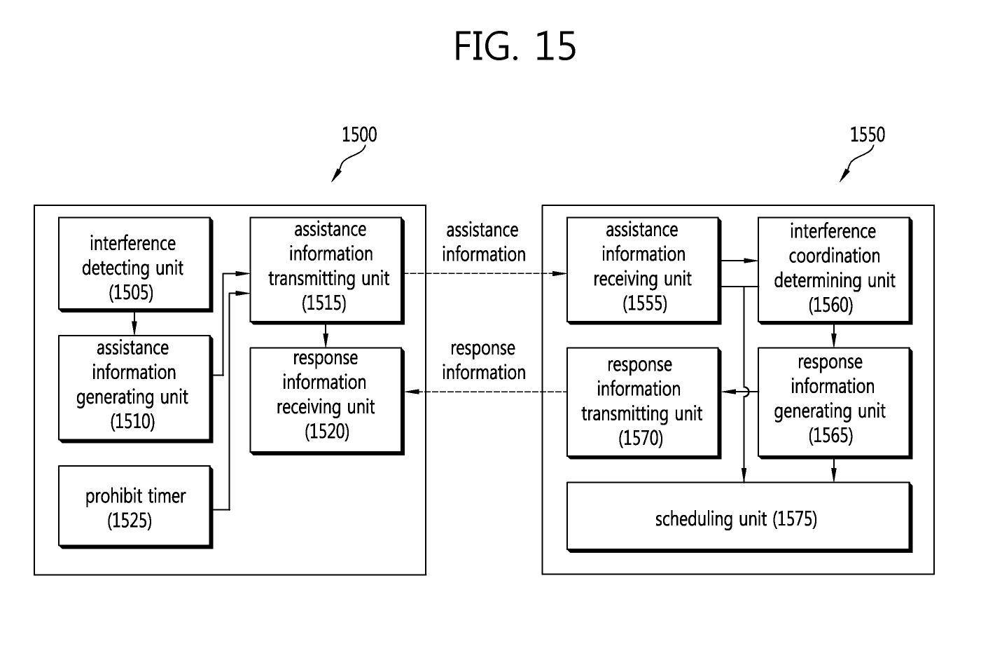

FIG. 15 is a block diagram illustrating an apparatus of transmitting and receiving information regarding in-device co-existence interference according to an embodiment of the present invention.

Referring to FIG. 15, the terminal 1500 and the base station 1550 exchange information regarding in-device co-existence interference. The information regarding in-device co-existence interference includes assistance information transmitted from the terminal 1500 and response information transmitted from the base station 1550.

The terminal 1500 includes an interference detecting unit 1505, a assistance information generating unit 1510, a assistance information transmitting unit 1515, a response information receiving unit 1520, and a prohibit timer 1525.

The interference detecting unit 1505 detects occurrence of in-device co-existence interference. For example, assume that, while receiving signal x from the base station 1550 through an LTE RF, the terminal 1500 transmits signal y through another RF such as WiFi. At this time, when the received signal to interference noise ratio (SINR) of signal y is not less than a predetermined threshold so that signal y acts as interference in signal x, the interference detecting unit 1505 may detect occurrence of in-device co-existence interference. At this time, the interference detecting unit 1505 measures the amount of interference caused by signal y and sends the result of interference measurement to the assistance information generating unit 1510. Here, although the interference detecting unit 1505 detects interference based on SINR, the present invention is not limited thereto, and the interference detecting unit 1505 may detect interference based on, e.g., RSRP (Reference Signal Received Power) or RSRQ (Reference Signal Received Quality).

The assistance information generating unit 1510 generates assistance information based on an interference measurement results obtained by the interference detecting unit 1505. By way of example, the assistance information includes the measurement results. That is, the assistance information includes measurement results such as SINR, RSRP or RSRQ. As another example, the assistance information includes an indicator indicating that in-device co-existence interference needs to be avoided based on an FDM scheme, together with the measurement results. As another example, the assistance information may be information supporting interference coordination based on an FDM scheme or may be information meaning that TDM scheme-based interference coordination is impossible. Here, in case the assistance information means that TDM scheme-based interference coordination is impossible, the assistance information may be a separate indicator indicating TDM impossibility or may be pattern information defining a blank transmission region for all the resources.

The prohibit timer 1525 is initiated when occurrence of in-device co-existence interference is detected so that interference information is transferred from the terminal to the base station. The prohibit timer is driven by applying a variable value that is previously determined or received from the base station.

Here, the in-device co-existence interference indication prohibit timer variable may have the form as shown above in Tables 2 to 5 and may include radio frame units, rf1, rf2, rf4, . . . , rf4096. By way of example, rf1 may mean one radio frame (10 ms), rf2 two subframes (20 ms), rf4 four subframes (40 ms), . . . , rf4096 4096 subframes (40960 ms).

As another example, instead of rf1, rf2, rf4, . . . , rf4096, subframe units, sf1, sf2, sf4, . . . , sf4096, may be used as in-device co-existence interference indication prohibit timer variables, and at this time, sf1, sf2, sf4, and sf4096 may mean one subframe (1 ms), two subframes (2 ms), four subframes (4 ms), and 4096 subframes (4096 ms). This is merely an example and the internal time value of the prohibit timer may be set by various methods.

Further, the variable for driving the prohibit timer may be set as a value that has been previously determined together with the base station without separate signaling.

Accordingly, before the internal time value of the prohibit timer 1525 gradually decreases and finally becomes 0, although in-device co-existence interference is detected (or although IDC triggering takes place), the terminal does not indicate whether in-device co-existence interference occurs from the terminal to the base station. In other words, before the prohibit timer expires, although occurrence of in-device co-existence interference is triggered, the terminal cannot inform the base station of occurrence of in-device co-existence interference. After the prohibit timer expires, the terminal may report occurrence of in-device co-existence interference to the base station according to IDC triggering.

The assistance information transmitting unit 1515 transmits assistance information to the base station 1550. The assistance information transmitting unit 1515 transmits assistance information to the base station in case the prohibit timer 1525 expires that prevents interference information from being transferred to the base station during a predetermined period of time. At this time, the assistance information transmitting unit 1515 may transmit the assistance information through an RRC message, an MAC message or physical layer signaling.

The base station 1550 includes a assistance information receiving unit 1555, an interference coordination determining unit 1560, a response information generating unit 1565, a response information transmitting unit 1570, and a scheduling unit 1575.

The assistance information receiving unit 1555 receives assistance information from the terminal 1500.

The interference coordination determining unit 1560 determines whether to adjust in-device co-existence interference that occurs in the terminal 1500. The interference coordination determining unit 1560 may determine whether to perform interference coordination through the capacity of available resources in an avoiding band. For this purpose, the interference coordination determining unit 1560 may calculate the capacity of available resources in the avoiding band and determine whether the capacity of available resources in the avoiding band is sufficient. If, the capacity of available resources in the avoiding band is not enough, the interference coordination determining unit 1560 does not accept a shift of the terminal to the avoiding band according to an FDM scheme. On the contrary, if the capacity of available resources in the avoiding band is enough, the interference coordination determining unit 1560 accepts a shift of the terminal to the avoiding band and determines whether to perform interference coordination.

Or, the interference coordination determining unit 1560 may determine whether to perform interference coordination based on measurement results such as RSRP or RSRQ. A shift to a frequency band having low RSRP or RSRQ may be not preferable in light of the base station or terminal. Accordingly, from the point of view of the determination of capacity of available resources or priority of the RSRP/RSRQ, despite the avoiding band determined that there is the capacity of available resources, if the RSRP or RSRQ is too low, the interference coordination determining unit 1560 does not accept a shift to the avoiding band.

The response information generating unit 1565 generates response information indicating accepting or rejecting interference coordination depending on the determination made by the interference coordination determining unit 1560. The response information generating unit 1565 may configure response information in any one form among a cell reconfiguration message, a handover message, a frequency shift indicator and a frequency shaping indicator. Or, the response information generating unit 1565 may generate response information indicating interference coordination based on a scheme other than the FDM scheme, for example, TDM scheme.

The response information transmitting unit 1570 transmits the response information to the terminal 1500. At this time, the response information transmitting unit 1570 may transmit the response information through an RRC message, an MAC message or physical layer signaling.

The response information transmitting unit 1570 may signal prohibit timer setting values to the terminal. Or, a separate control information transmitting unit (not shown) may signal prohibit timer setting values to the terminal. At this time, the signaling may be RRC signaling, MAC signaling, or signaling by PDCCH. Here, the RRC signaling may be performed cell-specifically through a system information message or a terminal-specific value may be signaled terminal-specifically to each terminal. The system information message is a message broadcast to all the terminals in the corresponding cell.

Here, the in-device co-existence interference indication prohibit timer variables may have the form as shown in Tables 2 to 5, and may have radio frame units, rf1, rf2, rf4, . . . , rf4096. As an example, rf1 may mean one radio frame (10 ms), rf2 two subframes (20 ms), rf4 four subframes (40 ms), . . . , rf4096 4096 subframes (4096 ms).

As another example, instead of rf1, rf2, rf4, . . . , rf4096, subframe units, sf1, sf2, sf4, . . . , sf4096, may be used as in-device coexistence interference indication prohibit timer variables. At this time, sf1 may mean 1 subframe (1 ms), sf2 2 subframes (2 ms), sf4 4 subframes (4 ms), and sf4096 4096 subframes (4096 ms). This is merely an example and the internal time value of the prohibit timer may be set by various methods.

As an example of RRC signaling, e.g., the internal time value of the prohibit timer may be signaled using one variable in the RRC connection reconfiguration message. Further, the signaling may be conditionally determined depending on the terminal. That is, the in-device coexistence interference being able to be transmitted to the base station may be signaled by the base station only for predetermined terminals. At this time, as an example of the terminal being able to transmit a report indicating in-device coexistence interference to the base station, the terminal may inform the base station that the report indicating the in-device coexistence interference may be transmitted by transmitting terminal capability information to the base station.

The scheduling unit 1575 performs FDM scheme-based interference coordination depending on the determination mad by the interference coordination determining unit 1560. The interference coordination may be interference coordination based on cell reconfiguration, handover, frequency shifting, frequency shaping, or TDM scheme-based interference coordination.

The above-described embodiments are merely an example of the present invention, and various modifications and variations may be made to the present invention by those skilled in the art to which the present invention pertains. Accordingly, the embodiments of the present invention are provided to describe, rather than limiting, the present invention, and the scope of the present invention should be not limited to the embodiments. The scope of the present invention is defined by the appending claims, and all technical spirit of the equivalents of the present invention should be construed as included in the scope of the present invention.

1. A method of adjusting interference by a terminal in a wireless communication system, the method comprising:
detecting interference caused by transmission over a first frequency band of a first network system in reception over a second frequency band of a second network system;
transmitting, to a base station, assistance information to support coordination of the detected interference in a case where a prohibit timer is expired of preventing transfer of interference information during a predetermined period of time; and
receiving, from the base station, response information to accept or reject coordination of the detected interference in response to the assistance information

2. The method of claim 1, wherein the prohibit timer starts when the detected interference is transferred to the base station and is expired when a predetermined internal time value of the prohibit timer is 0.

3. The method of claim 2, wherein the internal time value of the prohibit timer is received from the base station through an RRC (Radio Resource Control) connection reconfiguration message.

4. The method of claim 2, wherein the internal time value of the prohibit timer is received through a system information message from the base station.

5. The method of claim 2, wherein the internal time value of the prohibit timer is on a per-radio frame basis or on a per-subframe basis.

6. The method of claim 1, wherein the assistance information is information indicating adjusting the detected interference based on an FDM (Frequency Division Multiplexing) scheme that separates the first frequency band and the second frequency band from each other.

7. The method of claim 1, wherein the assistance information includes any one of a RRC (Radio Resource Control) message, a MAC (Medium Access Control) message, and a PDCCH (Physical Downlink Control CHannel).

8. The method of claim 1, wherein the response information is information indicating shifting the first frequency band or the second frequency band by a predetermined offset.

9. The method of claim 1, wherein the response information is information indicating filtering part of the first frequency band or the second frequency band.

10. The method of claim 1, wherein the response information is transmitted and received through a message used in a cell reconfiguration procedure or in a handover command procedure.

11. A terminal performing interference coordination in a wireless communication system, the terminal comprising:
an interference detecting unit that detects interference caused by transmission over a first frequency band of a first network system in reception over a second frequency band of a second network system;
an assistance information generating unit that generates assistance information to support coordination of the detected interference;
an assistance information transmitting unit that transmits the assistance information to the base station in a case where a prohibit timer is expired of preventing transfer of the interference information during a predetermined period of time; and
a response information receiving unit that receives from the base station response information to accept or reject coordination of the detected interference in response of the assistance information.

12. A method of adjusting interference by a base station in a wireless communication system, the method comprising:
receiving from a terminal information regarding interference caused by transmission over a first frequency band of a first network system in reception over a second frequency band of a second network system;
determining whether to adjust the interference; and
transmitting to the terminal response information on accepting or rejecting the coordination of the interference.

13. The method of claim 12, wherein whether to adjust the interference is determined based on the amount of available resource of an an avoidable band that is a frequency band to avoid the interference.

14. The method of claim 12, wherein the information regarding the interference includes any one of Signal to Interference Noise Ratio (SINR), Reference Signal Received Power (RSRP), and Reference Signal Received Quality (RSRQ), and wherein whether to adjust the interference is determined based on the information regarding the interference.

15. The method of claim 14, wherein whether to adjust the interference is determined based on whether any one of SINR, RSRP, and RSRQ is smaller than a predetermined value.

16. The method of claim 12, wherein the response information accepting the coordination of the interference is information indicating a shift of the first frequency band or the second frequency band by a predetermined frequency offset.

17. The method of claim 12, wherein the response information accepting the coordination of the interference is information indicating filtering of part the first frequency band or the second frequency band.

18. The method of claim 12, further comprising transmitting to the terminal an RRC (Radio Resource Control) connection reconfiguration message including an internal time value of a prohibit timer that prevents transfer of interference information during a predetermined period of time.

19. The method of claim 12, further comprising transmitting to the terminal a system information message including an internal time value of a prohibit timer that prevents transfer of interference information during a predetermined period of time.

20. A base station performing interference coordination in a wireless communication system, the base station comprising:
an assistance information receiving unit receiving from a terminal assistance information that is information regarding interference caused by transmission over a first frequency band of a first network system in reception over a second frequency band of a second network system;
an interference coordination determining unit determining whether to adjust the interference;
a response information transmitting unit transmitting to the terminal response information on accepting or rejecting the coordination of the interference; and
a scheduling unit performing scheduling to adjust the interference.
